(19) United States
(12) Patent Application Publication
(10) Pub. No.: US 2002/0161701 A1
(43) Pub. Date: Oct. 31, 2002

(54) Debit or credit card transaction clearing house system

(76) Inventor: Todd Warmack, Tallahassee, FL (US)

Correspondence Address: Carnes, Cona & Dixon, Innovation Park, 1673 West Paul Dirac Drive, Tallahassee, FL, 32310-3763, US

(21) Appl. No.: 09/846,011

(22) Filed: Apr. 30, 2001

(51) Int. Cl. G06F 17/60

(52) U.S. Cl. 705/39

(57) ABSTRACT

The present invention is a system that provides real-time balance and usage by alerting the primary card owner of any suspicious and/or all purchases/debits. This provides a system that will offer real-time monitoring capabilities by providing a system with various substations. These sub-stations are integrated with the conventional credit host system and/or credit card provider system. Each sub-system or sub-station, is a computer code that enables each sub-system to act as separate entities. The entities work together to provide real time balance and usage information at the touch of a button enabling the credit card owner real-time decision making options on the particular card's account.

### BACKGROUND OF THE INVENTION

1. Field of the Invention

The present invention relates generally to a debit and/or credit card transaction clearing house system and more particularly to a debit and/or credit card transaction clearing house system that provides for real-time balance and usage by alerting the primary card owner of any suspicious and/or all purchase/debits or the like, in order to prevent fraudulent transactions and to inherently provide for real-time monitoring capabilities.

2. Description of the Prior Art

In today's dynamic society, monitoring credit card usage, as well as preventing credit card fraud is a tremendous challenge, which requires an effective solution. It can be seen that credit cards are a mainstream in today's society, used in lieu of cash or checks. It can easily be concluded that credit cards are the major source for monetary payment. With the endless use of credit cards, it can be difficult and time consuming for the credit card owner to track purchases and maintain acceptable balances, which can quickly lead to unforeseen debt issues by overspending on the part of the credit card owner. In addition to the added worry of overspending, credit card fraud, which is usually slow in detection, is a huge problem that continues to rise. When credit card fraud occurs during an in-person card transaction, the card issuer is ultimately responsible for the loss. With e-commerce continuing to rapidly grow, the problem of on-line credit card fraud has dramatically increased. E-merchants are held liable for any and all fraudulent transactions online, causing the e-merchant to pay for shipping charges, bank charge-back fees, and other additional costs associated with bad transactions. As a result, many e-merchants have had to sacrifice sales by approving fewer transactions to avoid the risks of on-line fraud. Many consumers are also weary about e-commerce transactions due to the increased risk of credit card fraud.

As a result of the wide acceptance of credit card spending, many devices and systems have been developed to further enhance credit card usage for the credit card holder, as well as the credit card companies and merchants. For example, U.S. Pat. No. 4,277,837 issued to Stuckert discloses a personal portable terminal for financial transactions which uses a personal data storage and transfer card with the aid of the personal portable terminal to continually monitor and record an individuals financial record. This device serves to enhance the concept of a cashless and checkless society by allowing the user to perform most banking, financial and assorted retail transactions.

Yet another example is seen in U.S. Pat. No. 5,696,908 issued to Muchlberger et al wherein disclosed is a telephone debit card dispenser and method that allows for a microprocessor controlled vending machine to automatically vend telephone debit cards while accepting card payment in cash and credit.

Another example is seen in U.S. Pat. No. 6,128,602 issued to Northington et al wherein disclosed is an open-architecture system for real-time consolidation of information from multiple financial systems. This patent provides for a system that will automatically consolidate information from a variety of financial systems into a single accounting system thereby.

Though these patents as described above, may have proven to be successful in their use, they do not provide the same benefits as the present invention. What is needed is a debit or credit card transaction-clearing house, which provides for real-time balance and usage in order to prevent fraud, as well as provide for real-time monitoring capabilities. Such a device should be efficient in preventing and reducing fraudulent purchases, as well as monitor valid purchases by providing for a device which will notify the credit card account holder via a predetermined means such as telephone message, e-mail, or facsimile of a credit card transaction, or the like, thereby allowing the credit card account holder to electronically cancel the transaction prior to funds being transferred.

As will be seen the present invention achieves the needs as identify above, by providing a system that will render real-time balance and usage history of a particular account. The system will be integrated into the existing credit card transaction model. Thereby providing a system that is non-obtrusive to the user of the conventional credit card transaction system. Innately, providing a system that is successful in achieving the desired results.

Hence it is seen that none of these previous inventions provide the benefits intended with the present invention, such as providing a debit or credit card transaction-clearing house that offers real-time balance and usage history for the card owner. Additionally, prior techniques do not suggest the present inventive system as disclosed and claimed herein. The present invention achieves its intended purposes, objectives and advantages over the prior art devices through a new, useful and unobvious system that is successful and advantageous to the credit card owner as well as the issuer of the particular card.

### SUMMARY OF THE INVENTION

The present invention is a novel and unique debit or credit card transaction clearing house system which provides for real time balance and usage information in order to prevent fraudulent use of the credit card, as well as to provide for real time monitoring capabilities. The system of the present invention will integrate into an existing credit card transaction model. This will enable the current conventional credit card transactional model to function in a normal mode yet allowing the present invention to provide financial transactional activity that is easily accessible to the credit card owner.

As is known conventionally, when a consumer wishes to utilize their credit and/or debit card, the card is typically swiped via a conventional scanner device and/or the pertinent numerical representation is entered manually to a particular terminal. This scanner/terminal identifies the card and transmits the particular numerical representation to the credit card host and dependent on the particular conventional charge system, at times may simultaneously transmit the same information to the credit/debit card provider. The credit card host or provider system reviews the transaction requests of the particular financial transaction and issues either an approval, decline or a warning. The approval would enable the transaction to be completed, the decline would cease the transaction, while the warning provides a means to investigate the particular card, such as calling a particular central processing network to determine the appropriate action on the particular card, such as confiscation or the like.

The present invention is designed to interface with the above-identified existing system to enhance its functionality and provides a real-time means of financial activity, which is accessible to the cardholder. Consequently providing a system that alerts the main credit card owner of any and all financial transactions that occur with the owner's particular card. Such a system will allow the owner of the particular card the chance to accept, deny, or flag the particular transaction. In order to allow for real-time transaction alertness to the owner, the system of the present invention is comprised of various sub-systems or sub-stations that are integrated with the conventional credit host system and/or credit card provider system.

Each sub-system or sub-station, is a computer code that enables each sub-system to act as separate entities. The entities work together to provide real time balance and usage information at the touch of a button enabling the credit card owner real-time decision making options on the particular card's account.

Providing successful usability requires the use of a first sub-system known as the controlling system. This sub-station includes a database for each member. The members provide the pertinent information for rendering proper notification and identification. Each member is assigned a proxy number.

The controlling system, known as the fraud alert/proxy, is capable of recording and posting the financial transactions of the particular card and seeks authorization request within the security host, also known as the existing credit card host and/or provider system. The security host is the company or system that is hosting the system of the present invention.

At this controlling system or sub-system, when a transaction occurs to a particular card, the sub-system identifies the owner of the particular card and initiates the owner's assigned proxy number. The proxy includes a fraud alert ledger, which is a log that records all financial transactions and records all means for notifying the owner of the particular card. When activity has occurred with the particular card, the controlling system must send a “proxy in use” message to the second and third sub-systems. The “proxy in use” message alerts the subsequent sub-systems that a particular card is in use. This sub-system or the controlling system remains open until a response is received from a subsequent substation.

Activation of the controlling system causes the second sub-system to be activated. This second sub-station, known as the owner notify, is the sub-station that actually sends the “transaction in progress” notice to the card account owner by a predetermined method as identified in the first data base. Notification can occur via the use of facsimile, pager, e-mail, telephonic means or the like.

Activation of the second sub-system, causes the third substation to be activated. This third sub-system, known as the owner feedback, allows the owner to respond to the “transaction in progress”, that was sent via the second sub-system. The owner has the ability to accept, reject or flag the pending transaction.

The present invention provides a system that will adequately and efficiently alert the main card owner of all transactions occurring with their credit card. Such a system will aid in monitoring false and/or fraudulent transactions, to inherently reduce if not eliminate the need for the merchant and/or host to take a loss for a fraudulent charge. In addition, the present invention will provide an accurate monitoring of the credit card use, which can be instrumental to the owner and aid in the user's expenditure plans and filing system. Other benefits of the present invention includes a security buffer for the merchant who accepts the particular card, as well as banks and providers involved in the processing of the particular financial transaction.

Utilizing the present invention is instrumental in reducing fraudulent activities. Providing the ability to post an alert flag regarding the next debit or credit card transaction presented against the user's account will innately reduce multiple unauthorized usage. Thereby, providing a system that is extremely useful and beneficial to the owner, credit/debit card provider and credit host system.

Accordingly, it is the object of the present invention to provide a unique and novel debit or credit card transaction clearing card system which provides for real time balance and usage information for inherently preventing credit card fraud to occur. The present invention will also provide the credit card owner with real time credit card monitoring capabilities and thus will adequately and efficiently provide monitoring capabilities to innately provide for instantaneous fraud notification by the credit card owner.

Yet another object of the present invention is to provide the owner of the debit or credit card a means to respond to each and every transaction so as to provide a verification system for the credit card owner, this verification system will have a particular time frame so as to provide for a limited time to cancel any credit card transaction electronically.

Another object of the present invention is to provide a system with an inherent security buffer for the merchant who accepts the debit or credit card, as well as the banks involved in processing the transaction, by enabling the credit card owner to re-check and re-verify each and all transactions when they occur.

Yet another object of the instant invention is to provide the ability to post an alert flag regarding the next debit or credit card transaction presented against the users account in order to reduce multiple unauthorized usage, especially with multiple cards issued on one account.

Still another object of the present invention is to provide real time balance and usage credit card information in accordance with the preceding objects and which will conform to conventional forms of manufacture, be of simple construction and easy to use so as to provide a device that would be economically feasible, long lasting and relatively trouble free in operation.

Although there have been many inventions related to credit and debit card fraud none of these inventions provide the real time credit card balance and usage and fraud alert provisions which are provided with the present invention.

The foregoing has outlined some of the more pertinent objects of the invention. These objects should be construed to be merely illustrative of some of the more pertinent features and application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWING

FIG. 1 is a block diagram, which depicts the system of the present invention.

FIG. 2 is a conceptual flow diagram of the structure of the system of the present invention.

FIG. 3 is a block diagram, which depicts an alternative configuration of the system of the present invention.

FIG. 4 is a conceptual flow diagram of an additional sub-station that can be included in the system of the present invention.

Similar reference numerals refer to similar parts throughout the several views of the drawings.

### DESCRIPTION OF THE PREFERRED EMBODIMENT

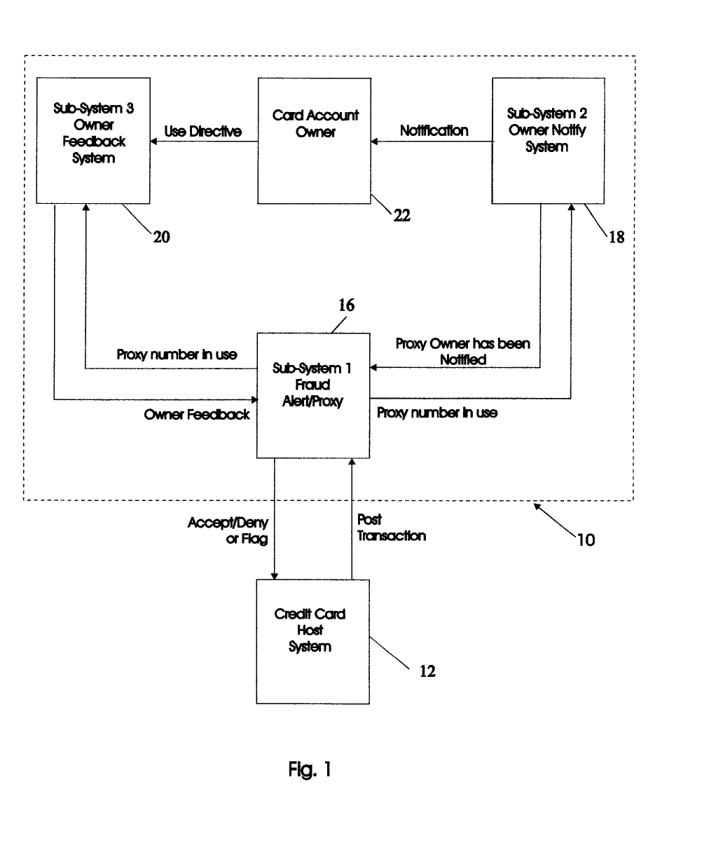

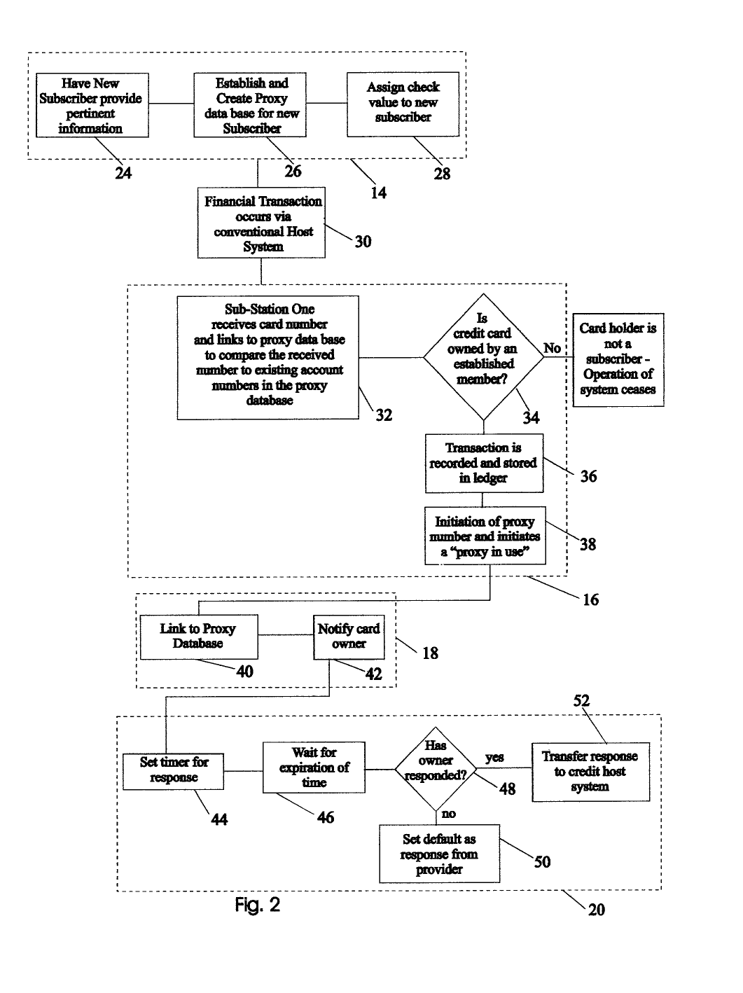

With reference to the drawings, in particular to FIG. 1 and FIG. 2, there is shown a block diagram and a conceptual flow diagram, respectively, which depict the system 10 of the present invention. As seen the present invention 10, illustrated in outline in FIG. 1, will be integrated into an existing credit card host and/or provider system 12. The purpose of the present invention is to provide a means of alerting the main credit card owner of any and all transactions that have occurred. These transactions will alert the credit card owner of usage and to avoid fraudulent activities and offer real-time monitoring capabilities.

Specifically, the invention, a debit and/or credit card transaction clearing house system 10, provides for the utilization of several sub-stations that are linked to the existing credit card host and/or provider system 12.

These sub-stations will analyze data efficiently and economically as well as provide a means of recording financial transaction of the particular card and notify the owner of the card in question of the instant transaction. Each sub-station consists of computer code defining the functions necessary to analyze and record the entered data and to execute the appropriate action once a result has been met. The sub-stations are in independent form, thus allowing each sub-station to operate independently and as separate entities. Each substation is distinct and accomplishes a specific purpose and each is combined with one another to successfully accomplish the task at hand, which is to alert the credit card owner of any and all transactions. In addition, the present invention provides for real-time balance and usage history of the particular card.

Enabling successful operation, a user must first be a subscriber to the present invention. When subscribing to the present invention, the owner of the particular card must first activate an intake module 14 (illustrated in the conceptual flow diagram of FIG. 2). This intake module 14 will include questions that are pertinent and necessary for administering the present invention successfully. Once the intake module 14 has been administered, the data collected is stored in a data bank known as the proxy databank 26. The data that is collected includes the owner's account number. Optionally, to provide added security and provide complete confidentiality for the subscriber, each subscriber is assigned a check value or client identification number 28. The data collected can be basic demographically information has well as include the check value which can be numerical representation, adjective, noun or name of significance to the owner. In addition, the preferred mode of contact, i.e. system of present invention contacts the subscriber via facsimile, pager, electronically, or by utilizing a telephone, will also be stored in this proxy databank.

Once a subscriber is entered into the system, the system operates and functions in a normal mode. Thus when a card is utilized, the present invention is activated.

In a simplified explanation, as seen in FIG. 1, the credit card host and/or provider system 12 is coupled to the present invention 10 via the first sub-station 16. In use, when a card, such as a credit card or debit card is utilized, it's check value or account number is forwarded to the first station. At this first station, the number is compared to the existing proxy data bank. If no match is made, then the cardholder is not a subscriber and the present invention ceases in operation. If a matched is made, the first station sends a signal to the second station 18 for activation. This second station 18, known as the owner notify system, will physically notify the owner 22, as preferred and as indicated via the intake database.

Once the owner has been notified, the third station or the owner feedback system 20 is activated. This system is activated until the owner hears a response. The owner 22 contacts the present invention via this station and indicates the procedure for the particular financial transaction. With the present invention, the cardholder can accept, deny or flag the particular transaction. This transaction is then forwarded to the credit host system.

Providing successful usability requires the first sub-system 16 known as the controlling system to be linked to the proxy database of the intake module 14 (illustrated in FIG. 2). For security purposes, in the preferred embodiment, each account holder includes a proxy number. Thus when posting any financial transaction, the proxy number and not the card account number will be posted to the owner of the credit card. This proxy number or check value 28 as identified in the conceptual flow diagram in FIG. 2, need not be a number, but rather a form of verifying the card holder to the particular account and thus provide for the “proxy number” to be any type of check value such as a random number, the owner's mother's maiden name or the like.

At this controlling system 16, known as the fraud alert/proxy is linked to the proxy database 32. When a card is utilized on the host and/or provider system, it is forwarded to the controlling system 32. This provides for the controlling system to be coupled to the existing host system. Once received, the controlling system 16 compares the received number with the proxy database to see if a match has occurred 34. If there is not a match, then the cardholder is not a subscriber and the present invention ceases in operation. If a match occurs, the transaction is recorded and stored in a ledger database 36. This matched number initiates the proxy number and initiates the “proxy in use” status 38.

Activation of the “proxy in use” status cause the second sub-system 18 to be activated. This second sub-station 18, known as the owner notify, is the sub-station that actually sends the “transaction in progress” notice to the card account owner, thus providing for the second substation to link with the proxy data base 40. Once linked, the second sub-station reviews the database and selects the notification mode for notifying the subscriber as indicated in the proxy database 42. Notification can occur via the use of facsimile, pager, e-mail, telephonic means or the like.

After contact has occur with the credit card holder, the third sub-system 20 is activated. This sub-system awaits the response from the owner so as to provide a response to the credit host. A time limit 44 can be provided, so as to provide for a certain amount of time to pass for enabling a response to the credit host. After the expiration of time 46, the system determines if the owner has responded 48. If the owner has not responded, a default is set as “provider”. This will enable the transaction to proceed with the authority given by the provider of the particular card. If the owner has responded, then the owner has the ability to accept, reject or flag the pending transaction. The acceptance or default is forwarded to the credit host. The transaction remains stored in the database and the response/default is stored in a response database for further review by the owner.

In utilizing a time frame for response, the present invention can allow the user to respond immediately or optionally at a later time. If the card has been stolen and fraudulent activities are occurring, the use of a later time response will not prevent an immediate transaction from occurring, but rather, will prevent subsequent transactions from occurring. The fraudulent activities will come to the owner's attention on the day of occurrence rather than the date the statement is received, which can be days or weeks after the fraudulent charge. The use of the present invention will provide for real-time review, which will provide a system that will adequately and efficiently alert the main card owner of all transactions occurring with their credit card.

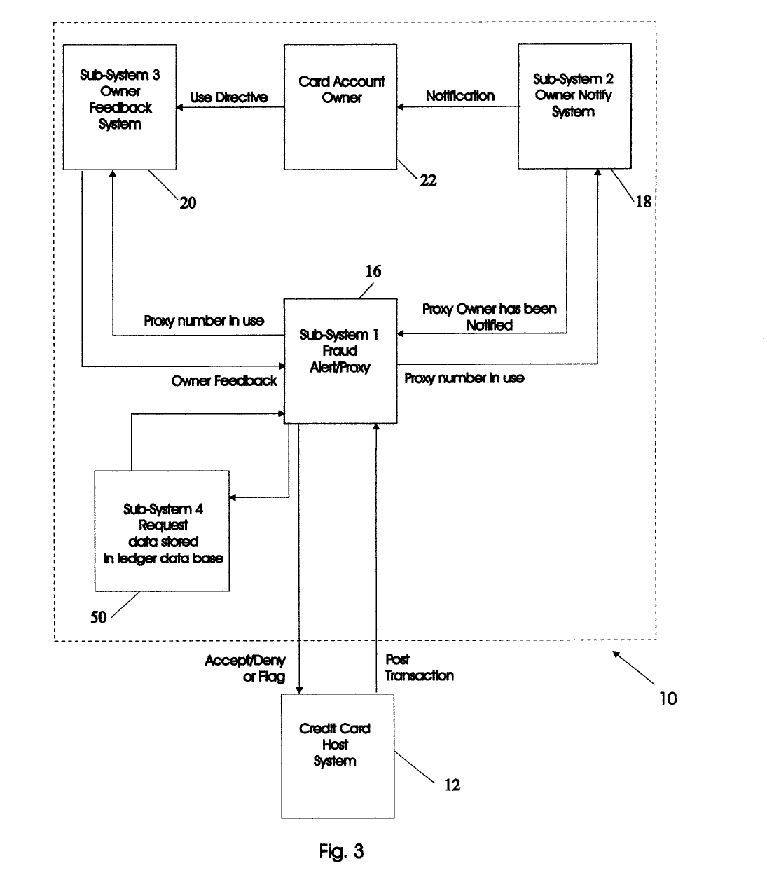

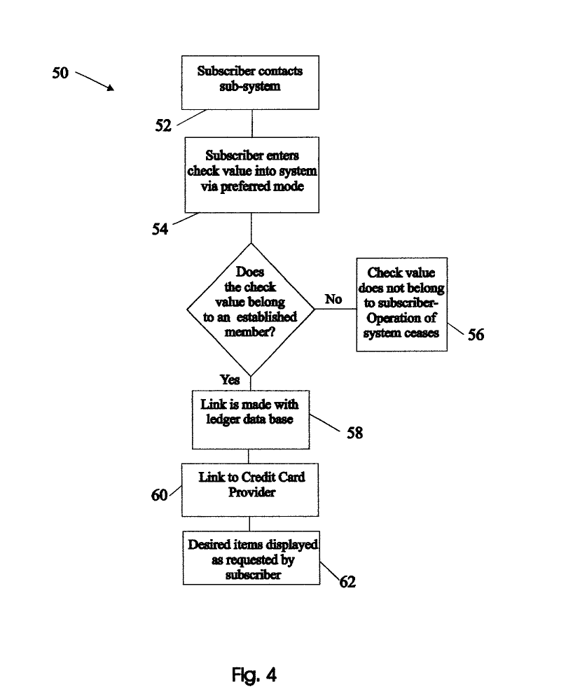

In an alternative arrangement, a forth sub-station can be provided. This alteration is shown in FIGS. 3 and 4. As seen in these drawings the fourth sub-station or sub-system 50 will provide a means for the credit card owner to obtain information and access to his account. In this configuration the fourth sub-system will link with the ledger database for enabling all transactions to be viewed by the owner. Such an arrangement will provide a visual means of viewing one's account.

To enable such a configuration, the fourth sub-station 50 will allow the credit card member to access this substation as desired, such as accessing the substation via the use of a telephone or computer or the like. Once access has been made 52, the subscriber enters the check value into the system 54. This is a safety feature and prevents unauthorized individuals from accessing the account.

If the check value does not match the account of the credit card or check value is not entered, the present invention ceases in operation 56. If the check value is a match, then the sub-station continues. Once a match has occurred, a link is made with the ledger database 58 and a link is made with the credit card provider 60. The credit card owner requests the desired item, i.e. credit balance, interest rate, payment date 62. The fourth sub-system retrieves the desired data from the linked databases. This provides the accurate and current data available, which can easily be retrieved by merely accessing the account as desired by the owner.

Alternatively, the forth sub-system can be linked with the second sub-station. This will enable automatic download of the subscribers account information each time contact is made between the second substation and the pre-determined means of contact as determined in the intake module 14. Thereby providing account information such as credit balance, payment due date, and the like, at the touch of a button.

### EXAMPLES

In utilizing the present invention, by way of example, a cardholder presents a card number as payment for goods or services to a merchant who then summits a charge request, by means of a point of sale (POS) terminal, to the Credit Host. This request is passed throughout to the credit card provide (MasterCard, Visa, American Express, Vovus) for authorization. The present invention provides a small time delay window for immediate response and/or a longer window, for example four hours, for delayed response. If the credit host does not receive a response from the cardholder within the immediate window timeframe, the system of the present invention defaults the response to the authority given by the provider, so as to complete the transaction.

### Example 1

John and his wife Mary have a joint VISA credit card wherein John is the main cardholder. John and Mary have enrolled in the credit card transaction clearing house system of the present invention. Mary makes a purchase at a department store utilizing the joint VISA credit card. When the authorization request reaches the provider a simultaneous proxy call is made to John's cell phone. When John answered, a short beep alerted him that this was a digital communication so John was able to view the incoming message on the screen of his hand held Mobile telephone. The message read that a charge of $129.00 was attempting to be posted to his account from a particular department store. Knowing that his wife was to be shopping on this day made him aware that the purchase was legitimate. He was then given the option to cancel the transaction by pressing the #5 key. John elected to not respond and this election meant that the transaction was accepted by default. John also did not respond to the optional delayed response window and no further action was required.

### Example 2

Unknown to Richard, one week earlier an individual retrieved a copy of his credit card receipts from the trashcan of a local gas station. The receipt included Richard's account number. A few days passed and the individual decided to order new stereo equipment utilizing the stolen credit card number. The individual posing as Richard submits the card for authorization. Moments later, Richard receives a call. Hearing that familiar beep, he reads the digital message displayed on the screen of this mobile phone. The message reads “PAR (Purchase Authorization Request) $1700 Shades Stereo Wholesale” Press #5 to cancel, Press #1 to accept or press #9 to flag.

Richard has thirty seconds to respond. Knowing that he did not purchase anything with his card and since he has never heard of Shades Stereo Wholesale, Richard flags the account by depressing #9 key. The flagging notifies the provider to suspend all further charge attempts on Richard's account until further resolution can be made or a new card issued.

While the invention has been particularly shown and described with reference to an embodiment thereof, it will be understood by those skilled in the art that various changes in form and detail may be made without departing from the spirit and scope of the invention.

I claim:

1. A credit card transaction clearing house system comprising:
a plurality of sub-systems;
each sub-system is a computer code;
a data base for recording pertinent data of a customer and said data base is linked to at least one of said plurality of sub-systems;
at least one sub-system provides for real-time owner notification for each credit transaction.

2. A credit card transaction clearing house system as in claim 1 wherein at least one sub-system includes an owner feedback capability.

3. A credit card transaction clearing house system as in claim 2 wherein said owner feedback capability is coupled to a timer for timing said owner feedback capability.

4. A credit card transaction clearing house system as in claim 1 wherein a proxy sub-system is provided and said proxy sub-system analyzes, records and organizes each transaction in a ledger data base.

5. A credit card transaction clearing house system as in claim 1 wherein at least one sub-system includes an account access capability for enabling access to said account and illustrating each credit transactions that has occurred.

6. A credit card transaction clearing house system as in claim 4 wherein at least one sub-system is coupled to said ledger data base for enabling access to said ledger database when desired.

7. A credit card transaction clearing house system as in claim 1 wherein at least two sub-systems are provided, a first sub-system analyzes, records and organized each transaction in a ledger data base and a second sub-system includes an owner notification system

8. A credit card transaction clearing house system as in claim 7 wherein at least three sub-systems are provided, a third sub-system provides for an owner feedback capability for enabling response for each transaction.

9. A credit card transaction clearing house system as in claim 8 wherein at least four sub-systems are provided, a fourth sub-system provides account access and access to said ledger data base when desired.

10. A credit card transaction clearing house system as in claim 2 wherein a safety code is provided and said safety code must be utilized properly for enabling response to said owner feedback capability.

11. A credit card transaction clearing house system comprising:
a plurality of sub-systems;
each sub-system is a computer code;
a data base for recording pertinent data of a customer and said data base is linked to at least one of said plurality of sub-systems;
at least one sub-system provides for real-time owner notification for each credit transaction;
at least one sub-station provides access to account information.

12. A credit card transaction clearing house system as in claim 11 wherein at least one sub-system includes an owner feedback capability.

13. A credit card transaction clearing house system as in claim 12 wherein said owner feedback capability is coupled to a timer for timing said owner feedback capability.

14. A credit card transaction clearing house system as in claim 11 wherein a proxy sub-system is provided and said proxy sub-system analyzes, records and organizes each transaction in a ledger data base.
